(19) United States
(12) Patent Application Publication
(10) Pub. No.: US 2006/0036530 A1
(43) Pub. Date: Feb. 16, 2006

(54) Method and apparatus for facilitating micro energy derivatives transactions on a network system

(76) Inventor: Gary Shkedy, San Diego, CA (US)

Correspondence Address: F. CHAU & ASSOCIATES, LLC, 130 WOODBURY ROAD, WOODBURY, NY, 11797, US

(21) Appl. No.: 10/915,048

(22) Filed: Aug. 10, 2004

(51) Int. Cl. G06Q 40/00; G06Q 99/00; G06F 7/00; G06F 17/00; H04L 9/00; H04K 1/00

(52) U.S. Cl. 705/37; 705/64; 707/100

(57) ABSTRACT

A system and method and device for using a computer to facilitate the issuance and redemption of energy related micro derivative contracts between a buyer and an seller, including a customer determining the derivative contract to be purchased and swiping the card through the card reader. The customer then submits the order to the central controller. At that point, the central controller will store the order in the database. The buyer then submits the contract to the central controller to request to redeem the contract. The central controller then validates the contract and if it is valid authorizes the delivery of the energy product to the customer.

### TECHNICAL FIELD

The present invention relates to a method and an apparatus for facilitating transactions on an electronic commercial network system and specifically to a method and system for facilitating the issuance and redemption of micro energy derivative contracts.

### DISCUSSION OF RELATED ART

Historically, there have been numerous events such as wars, sudden deregulation, riots, stoppages, natural disasters, supply crises, labor unrests, etc., that have caused spikes in the prices of energy sources like gasoline, electricity or natural gas. Unlike other commodity consumers, energy consumers are unable to buy “insurance” or derivative contracts that would protect them from the volatility in the energy market caused by such shocks to the energy supply. If the consumers facing such unpredictable energy crises could purchase derivative contracts they could either lock in the current price or buy insurance to protect them against huge price swings.

Energy derivative contracts (e.g., options, futures contracts, Asian options, lookback options to name a few—hereafter generally referred to as “derivatives”) are normally traded on the financial exchanges or over the counter by major brokerage firms and are useful for managing the risks associated with the buying and selling of energy products. Currently, derivatives are available for all the major energy products, and specifically for: light sweet crude, natural gas, heating oil, unleaded gasoline, propane and electricity.

The typical contract sizes for energy derivative contracts are very large, for example, 42,000 gallons of unleaded gasoline, 1000 US barrels of light sweet crude oil or 4000 million BTU for the “mini” natural gas contract. The target markets for these products are the corporation in the energy business such as refineries, oil producers, institutional or professional energy consumers. For example, the major airlines frequently make use of derivatives to manage the cost of aviation fuels. On the other hand, the owner of a small taxi fleet is unable to lock in the price of his gasoline, and so his profits become very volatile as the price of gasoline fluctuates.

The practice of using derivatives to manage risk in energy products is well known in the art and need not be described here in detail. For reference, one of ordinary skill in the art may refer to John C. Hull, Options, Futures and Other Derivatives (5th Ed, Prentice Hall, 2002) or Energy Risk Management by Peter Fusaro (McGraw Hill, 1998).

The advent of prepaid telephone cards has educated consumers in the use of “forward contracts” in the sense that the consumer has contracted to purchase a given amount of minutes from a designated carrier at some point in the future. Additionally most prepaid cards also have an expiration date beyond which, the contract will expire to be worthless. However, the price of a telephone call is not as volatile as the price of, say, gasoline and thus a prepaid gasoline card would require much more sophisticated planning and hedging on the part of the seller. Also the price of energy varies from state to state and so either the pricing of the prepaid card or the delivery of the underlying product becomes more complicated. Hence, there is a need for micro derivative contracts that would allow smaller consumers to hedge the risks of inflationary fuel prices.

However, micro derivative contracts on energy products would be of enormous value to these consumers, but they do not exist in the current marketplaces. For example a micro derivative contract can be an unleaded gasoline contract for about 50 to 100 gallons, which is the typical monthly gasoline usage of a typical individual consumer. One of the major obstacles to micro derivative contracts is the trading costs associated with the buying and selling of derivative contracts. For example, at current prices, it costs about $12 to trade a single option contract with the cheapest broker in the USA. Other brokers charge as much as $50 to trade a single contract. Assuming that a three-month micro option on gasoline could cost $2 in premium and a one-month micro option contract may cost $0.50, even the cheapest $12 transaction cost would stifle any attempt to trade micro derivatives.

Another major barrier for development of derivative fuel contracts in the present marketplace is that the contracts on the major exchanges are for delivery of the energy product at a specific location, e.g., the unleaded gasoline contract is for delivery in the New York harbor. This makes it useless for a consumer in the Californian market who only uses 50 gallons a month on an average. Micro derivative contracts could be structured so that the delivery of the underlying energy commodity could be in any specific geographic location, such as within any given zip code or at any particular gas station desired by the consumer. Hence, there is a need for such delivery point independent micro derivative contract and a trading system for such contracts.

Another important aspect of the micro-derivative contracts is that they can be used as a loyalty reward for consumers of a particular brand of energy. For example, a retail gasoline company could offer the contracts to its customers provided that they redeem the contract at a participating gas station affiliated with that particular retail gasoline company. This would help ensure customer loyalty and could be constructed in such a way that the seller pays the premium. Therefore, there is a need for a micro derivative contract system that can be readily utilized as a loyalty reward system or be linked to an existing reward system.

Despite recent advances in computers, electronic network technology and wireless technology and the explosive growth in electronic commerce (e-commerce), applicant is not aware of a commercially viable market in micro derivative contracts on energy products, wherein consumers can buy and redeem micro derivative contracts for their energy consumption.

### SUMMARY OF THE INVENTION

In one aspect of the invention, a system and method for using a POS device and a computer to facilitate a transaction between a buyer and a seller includes a customer submitting an order to the central controller. The central controller authorizes the contract that is issued to the buyer. If the buyer is redeeming the contract then the customer submits the details of the contract to the central controller; the central controller authenticates the contract; and the central controller issues authorization for sale of the energy commodity at the contract price.

A system and method provides individuals with the ability to buy and redeem micro derivative contracts on energy products, thereby effectively locking in the prevailing market price by buying price protection insurance. At present, the individual energy consumers are forced to bear market risk and pay higher prices when these products are in short supply. Therefore, it is one aspect of the present invention to provide a method and a system for facilitating the issuance and redemption of micro energy derivative contracts.

An aspect of the present invention is to allow the buyer to pay for the contract using cash. Another aspect of the present invention is to allow the buyer to pay for the contract using a credit card. An aspect of the present invention for the buyer is to buy the contract on credit and have the system communicate with the seller's accounting system. Another aspect of the present invention is to allow the buyer to pay a premium for his current usage of energy, where that premium is then used to automatically purchase a derivative contract. It is yet another aspect of the present invention to allow buyers to redeem the contracts for cash.

The buyer can redeem a previously purchased micro derivative contract by receiving the energy product at a future date. Alternately, the buyer can assign the contract to another buyer or any other third party. Further, the buyer can redeem the micro derivative energy contract for cash.

In another aspect of the invention the buyer redeems the contract by purchasing the underlying physical energy product for the price agreed in the contract. Another aspect of the invention allows the buyer to prepay for the underlying physical energy product that the buyer will later collect as part of the redemption process.

These and other aspects, features and advantages of the present invention will become apparent from the following detailed description of illustrative embodiments thereof, which is to be read in connection with the accompanying drawings in which the same reference numerals are used throughout the various figures to designate same or similar components.

### BRIEF DESCRIPTION OF THE DRAWINGS

FIG. 1 illustrates a block diagram of an embodiment of the present invention;

FIG. 2 is a block diagram showing an exemplary central controller in an embodiment of the present invention;

FIG. 3 illustrates an exemplary flow of an issue transaction;

FIG. 4 illustrates an exemplary flow of a redemption transaction;

FIG. 4A is a block diagram showing an embodiment of the buyer interface;

FIG. 5 illustrates an embodiment showing how a buyer order is generated;

FIG. 6 illustrates an embodiment showing the acceptance of a buyer order and credit card payment by the central controller;

FIG. 7 illustrates an embodiment showing how a buyer redemption order is generated;

FIG. 8 illustrates an embodiment showing the acceptance of a buyer redemption order and payment authorization by the central controller; and

FIG. 9 illustrates an embodiment showing the use of a certificate authority and a settlement server.

### DETAILED DESCRIPION OF PREFERRED EMBODIMENTS

A system and method according to the present invention is provided for facilitating the issue and redemption of micro derivatives on energy products. The term “micro derivative” contract as used here in context of energy and fuel related contracts indicates that the contract are of a type suitable to either individual or a small number of consumers. For example, one feature of such contract can be that it deals with an energy purchase of a relatively smaller value. Another could be a small amount of quantity of the fuel to be purchased under the contract. Another feature could be that the fuel would be available at the buyers location under the contract. Those skilled in the art will appreciate that many more such features can be used to define such micro contracts and the above listed examples are only given for illustration.

This is in contrast with conventional energy related derivative contracts that are typically large quantity, high value and destination specific. Such micro derivative contracts would typically be bought by relatively small consumers. For example, such small consumers can be individual consumers, groups of such consumers, non-profit entities and relatively small and medium size commercial organizations.

At least one aspect of the present invention provides a trading system for buyers wishing to buy contracts and redeem their contracts. The illustrative method and system according to the present invention provides the seller with a system for managing the issuance and redemption of derivative contracts that achieves a cost saving for both buyers and issuers. At least one aspect of the illustrative method and system, the present invention effectuates performance of resulting orders and redemptions, and authentication.

One aspect of the present invention is a viable facility for transacting micro derivative contracts and the ability to issue and redeem derivative contracts at a Point Of Service (POS) device. This is achieved by using the same magnetic cards that are used, for example, as department store gift cards or POS authorized prepaid phone cards. A POS system for gasoline stations is described in U.S. Pat. No. 4,395,626. The POS system could either be used by the buyer themselves or by a sales agent assisting the buyer.

Moreover, a system that can also utilize physical tokens that interact with POS device as a method of authenticating the buyer will be more likely to attract the attention of potential buyers, because they offer an ease of use normally associated with credit accounts. These tokens could be smart cards or a transponder similar to the smartcards that need only to be waived before a terminal to complete payment for a transaction. An example of a transponder payment system is disclosed in U.S. Pat. No. 6,073,840.

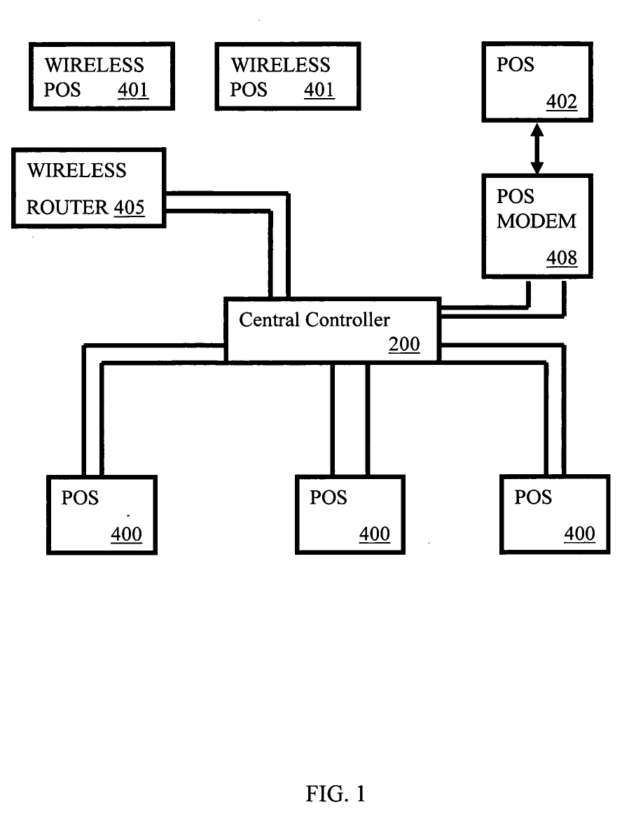

Referring now to FIG. 1, in a preferred embodiment, an electronic network including a central controller 200 is shown. The network facilitates communications between a plurality of buyers using a plurality of POS devices and a seller (i.e., central controller 200). FIG. 1 illustrates a plurality of POS devices coupled to one central controller 200 in a variety of manners. POS devices 400 are electronically connected to the central controller via Ethernet connections. Wireless POS devices 401 connect to the central controller via a wireless router that is electronically linked to central controller 200. POS device 402 connects to central controller with POS modems 408.

Each of the plurality of buyers who wish to make purchases, independently accesses the central controller 200 to create purchase orders using any of the POS devices. Examples of a POS system are the “G-SITE” system from Gilbarco Inc. which is a retail POS for the gasoline industry. Another POS system is the “REALPOS 80” from National Cash Register. An example of a wireless POS could be a HP IPAQ 555, which is a Bluetooth enabled PDA (Personal Digital Assistant). The wireless router can be a Linksys BEFW11S4 or any other wireless router. The central controller 200 is preferably located at a remote server.

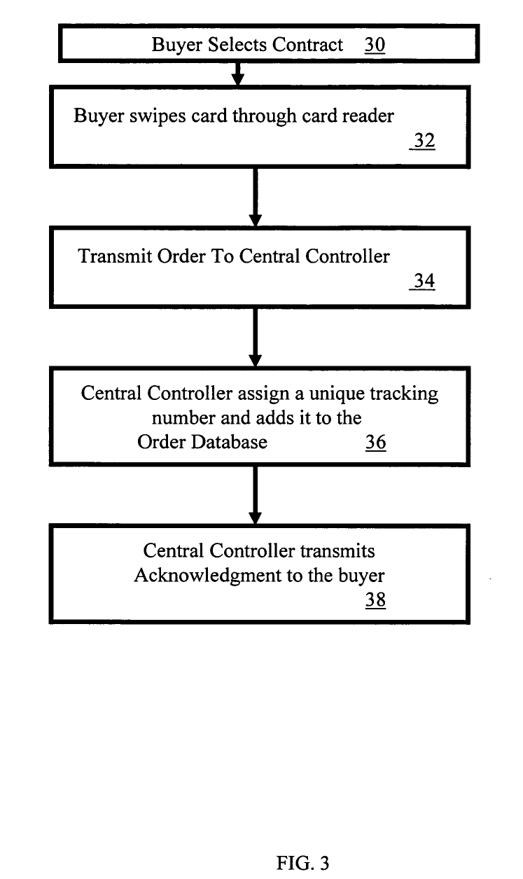

FIG. 3 illustrates the steps associated with the creation and inclusion of an order 100 into the order database 270. At step 30, a buyer 16 selects the particular contract he wishes to purchase. This most probably will be a buyer selecting a magnetic card from a display stand. At step 32, the buyer swipes the magnetic card through the card reader at the POS system. Again it may be a sales clerk that does the actual swiping of the card. At step 34 the buyer submits the contract to the central controller 200 for issuance.

A typical buyer created order, order 100, could, for example, specify that the buyer wishes to purchase a Mar. 31, 2005 option to buy unleaded gasoline at $1.95. This would be equivalent to purchasing an insurance policy that guaranteed the buyer could purchase 20 gallons on unleaded gasoline for $1.95 at any time up to Mar. 31, 2005 irrespective of what the prevailing market price happened to be.

At step 36, the central controller 200 assigns a unique tracking number to the order 100, timestamps it and adds it to the order database. The central controller 200 may require that the buyer 16 has sufficient credit in his account to cover the purchase price of the specified product. At step 38, the central controller 200 transmits an acknowledgement to the buyer. Instead of an acknowledgement code, the central controller could send an authorization code to the POS to authorize the order 100. Once s a buyer is authenticated and found to be credit worthy, the central controller would complete step 38.

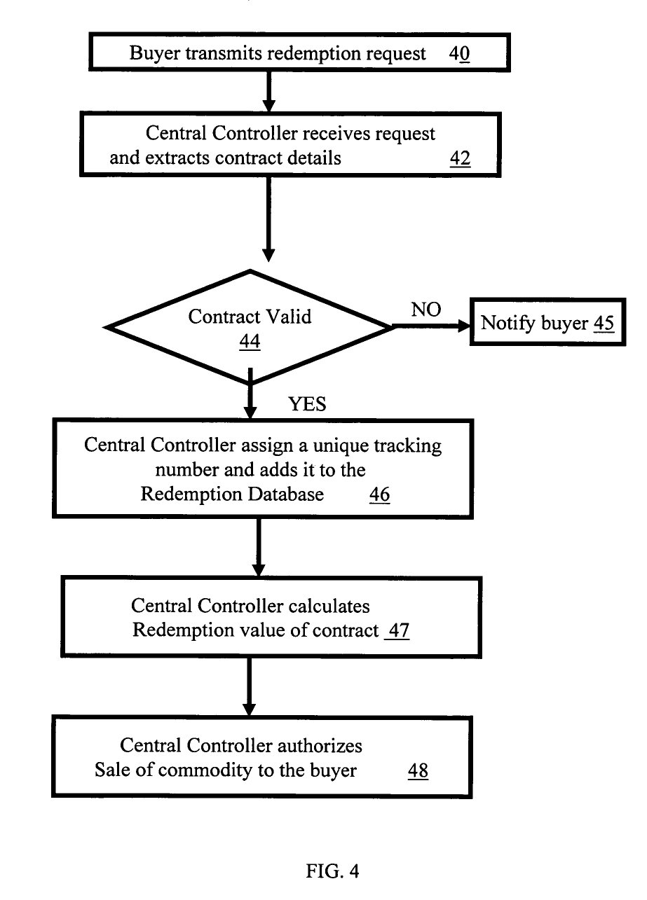

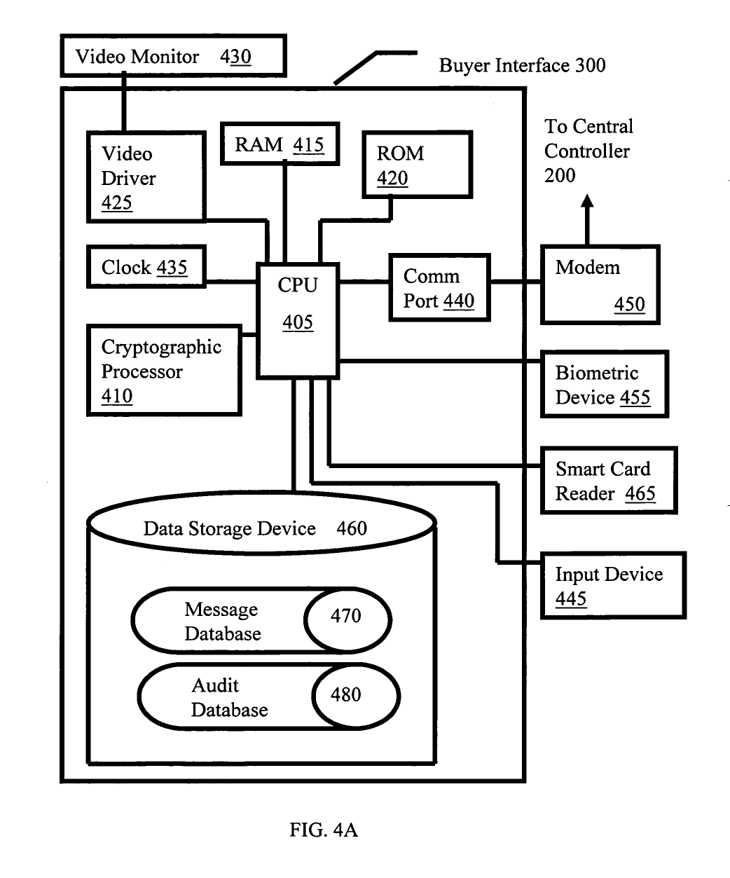

FIG. 4 illustrates the steps associated with the redemption of a micro contract 150. At step 40 the buyer submits his redemption request by transmitting it to the central controller 200. At step 42 the central controller 200 receives the request 155 and extracts the contract 150 from the request 155.

At step 44, the central controller 200 determines if it is a valid contract. If it is not, then at step 45, the central controller 200 notifies the buyer that the contract is invalid and the process terminates. If it is a valid contract, then at step 46 the central controller 200 assigns a unique tracking number to the redemption order 160 and stores it in the redemption database 280.

At step 47 the central controller 200 calculates the redemption value of the contract and at step 48 the central controller 200 authorizes sale of the underlying commodity to the buyer at the contract price.

In at least one embodiment of the present invention, communications between the various parties may be transmitted via numerous means including a worldwide-web interface, personal digital assistant (PDA), web enabled cellular phones, POS systems, electronic mail, voice mail, facsimile, or postal mail. Those skilled in the art would appreciate that the above mentioned transmission methods and devices are illustrative and the same does not limit the invention in any manner. Hence, any other suitable transmission methods or devices can be used.

At least one embodiment of the present invention can also be practiced in an off-line environment. Instead of using electronic mail or web-based servers, buyer 16s may communicate with the central controller 200 via telephone, facsimile, postal mail, or another off-line communication tool. For example, buyers may use telephones to create the orders 100 (with or without the assistance of live agents) as well as create redemptions 150 with the use of telephones.

Other embodiments may use cryptographic protocols to authenticate the identity of buyer 16s and verify the integrity of buyer 16's communications with the central controller 200. This would be useful in embodiments where the purchase of derivative contracts is made against the credit account of a buyer. The use of cryptography, smart cards and biometrics can make it significantly more difficult for unauthorized persons to tamper with the system by passing themselves off as legitimate buyer 16s or eavesdropping on system communications.

In another embodiment, buyer 16 could purchase a prepaid energy card that could then be authorized by the central controller 200. This is the equivalent of a prepaid forward contract that allows the buyer to take delivery of the specified amount of energy product at any point up to the expiration of the contract. In general, the buyer and seller of a micro derivative contract may specify any contractual term for supply of energy resources. For example, the buyer and seller can agree on a specific termination date of a given micro derivative contract.

In another embodiment, the buyer 16 could receive their selected contract in the form of a physical token 19. Such a token could be a plastic card with a magnetic strip (similar to a credit card), a smart card with an embedded chip, or a transponder similar to a SPEEDPASS from Mobil. Other tokens not explicitly enumerated herein are also within the scope of the invention.

In the same embodiment, buyer 16 could present the physical token 19 to a POS system to redeem their contract. The final payment the buyer would then make at the POS would depend on the redemption value of the contract.

Other embodiments may have the seller make use of selling agents who authorize and authenticate contracts through the use of seller interface 300. For example, such an interface could be a credit card terminal that would authorize energy cards and then validate them at the time of redemption.

One embodiment of the present invention divides the functionality of the central controller 200 into three components and embodies them in three separate servers: an operations server, a certificate authority, and a settlement server. The certificate authority authenticates the identity of buyer 16s while the settlement server verifies their ability to pay or deliver contracts. The operations server posts orders 100 relying upon messages from the other two servers for validation. This configuration allows for greater specialization of the servers.

Another embodiment of the present invention does not require a transfer of funds from seller 20 to buyer 16. Instead, the system may be used to consummate a contract involving an exchange of loyalty rewards, e.g., loyalty points, that can then be exchanged for other products and services. Similarly, the same loyalty points can be used by buyer 16 to purchase further contract(s) from seller 20 without the use of money.

In at least one embodiment of the present invention is a highly effective system for the issue and redemption of micro derivative contracts on energy products. The present invention provides numerous unique advantages including ease of purchase, delivery, reduced fees and portability.

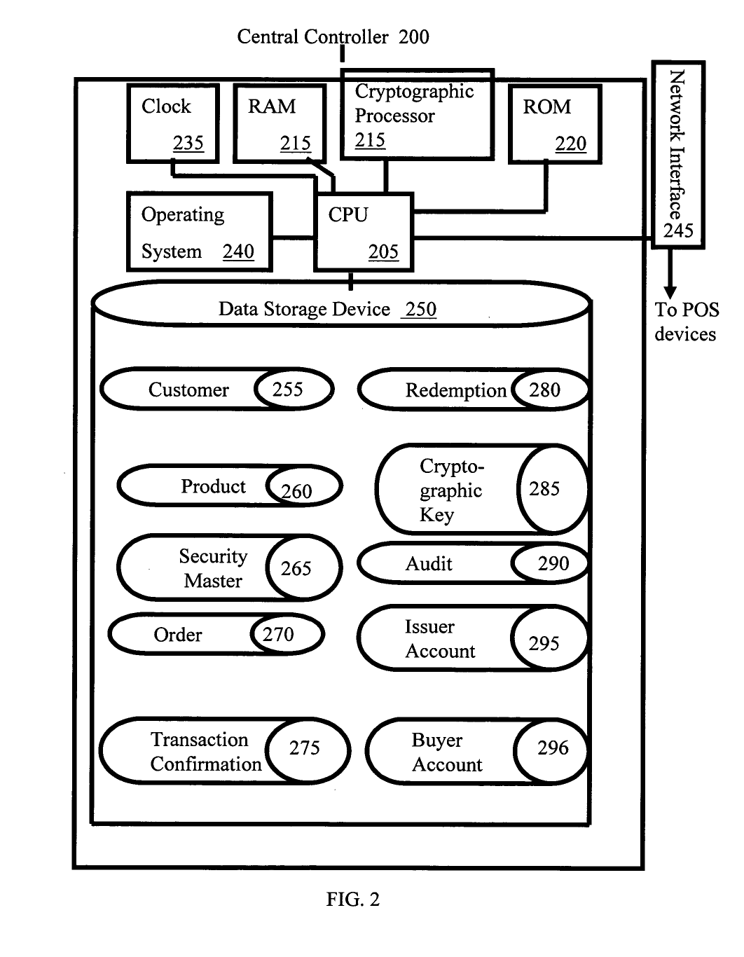

The present invention will now be discussed with reference to FIGS. 1 and 2. At least one embodiment of the present invention includes central controller 200 and POS 400, and associated databases. The present invention receives orders from buyers and then authorizes the contract. A buyer is able to redeem his contracts through the system.

A system architecture of at least one embodiment of the present invention is explained with reference to FIGS. 1 and 2. As shown In FIG. 1, an apparatus of the present invention comprises central controller 200, and POS 400 (collectively the “nodes”). Each node is connected via an Internet connection using a public switched phone network, such as those provided by a local or regional telephone operating company. Connection may also be provided by dedicated data lines, cellular, Personal Communication Systems (“PCS”), microwave, or satellite networks. Other embodiments may use other means of communication not enumerated herein. POS systems 400, 401 and 402 are the input and output gateways for communications with central controller 200.

Using the above components, the present invention provides a method and apparatus to issue and redeem micro derivative contracts in energy products.

As shown in FIG. 2, central controller 200 includes central processor (CPU) 205, cryptographic processor 210, RAM 215, ROM 220, payment processor 230, clock 235, operating system 240, network interface 245, and data storage device 250.

A conventional personal computer or computer workstation with sufficient memory and processing capability may be used as central controller 200. In one embodiment it operates as a web server, both receiving orders 100 and processing redemption orders 120, Central controller 200 must be capable of high volume transaction processing, performing a significant number of mathematical calculations in processing communications and database searches. A microprocessor, for example, an ITANIUM 2.1 GHz, commonly manufactured by Intel Inc., may he used for CPU 205. This processor employs a 128-bit architecture. Equivalent processors include the IBM's POWERPC 970 64 bit processor or Sun Microsystem's ULTRASPARC-III CU.

An MPC180 security processor, commonly manufactured by Motorola Inc. may be used for cryptographic processor 210. Suitable equivalent processors may also be used without limiting the invention in any manner. This 66 MHz micro-controller has a RSA signature time of 32 ms supporting 10 IKE handshakes per second. Cryptographic processor 210 supports the authentication of communications from buyers and sellers, as well as allowing for anonymous transactions. Ideally, cryptographic processor 210 may also be configured as part of CPU 205. Other commercially available specialized cryptographic processors include Phillip's 40 MHz VMS113.

Data storage device 250 may include hard disk magnetic or optical storage units, as well as CD-ROM drives or flash memory. Data storage device 250 contains databases used in the processing of transactions in the present invention. These include customer database 255, product database 260, security master database 265, order database 270, transaction confirmation database 275, redemption database 280, cryptographic key database 285, and audit database 295. In an embodiment database software such as ORACLE9i, manufactured by Oracle Corporation, is used to create and manage these databases. Data storage device 250 also stores information pertaining to seller account 295 and buyer account 296.

Customer database 255 maintains data on customers with fields such as account type, name, address, telephone number, ID number, electronic mail address, smart card ID, public/private key information, etc. This information is obtained when the customer first registers with the system, or immediately prior to posting his first order 100. Different information may be required for different account types e.g. individual accounts would require credit card information, etc.

Product database 260 maintains data on all the underlying energy products with fields such as product ID, product description, product availability, product provider, and where applicable a geographic area where the product is available. This database is a catalog of all the underlying products on which the derivative contracts are written.

Security master database 265 maintains data on all the specific derivative contracts that can be purchased. It has fields such as security ID, contract type, expiration, strike if applicable, product ID, etc. The security master database 265 is the catalog of derivative contracts that can be traded.

Order database 270 tracks all the order 100s with fields such as status, tracking number, date, time, security ID, customer ID and quantity. Transaction database 275 tracks the payment information regarding the order. Fields include customer name, customer ID number, order tracking number, type of payment, amount and associated credit card authorization number. Redemption database 280 tracks all payments made to the buyers and contract details with fields such as customer ID number, amount of payment, and associated order tracking number.

Cryptographic key database 285 facilitates cryptographic functions, storing both symmetric and asymmetric keys. These keys are used by cryptographic processor 210 for encrypting and decrypting orders 100.

Audit database 290 stores transactional information relating to the purchase of orders 100 and the redemption of redemption orders 160. Seller Account Database 295 tracks all payments made to and by the seller. This account may be a pointer to account data stored at the seller's bank.

Buyer account 296 tracks all information pertaining to the customer's account with fields such as customer ID, bank account numbers, and debit or credit transactions. This account may be a pointer to account data stored at the customer's bank.

Network interface 245 is the gateway to communicate with buyers through POS 400. Conventional internal or external modems may serve as network interface 245. Network interface 245 supports modems at a range of baud rates from 1200 upward, but may combine such inputs into a T1 or T3 line if more bandwidth is required. In a preferred embodiment, network interface 245 is connected with the Internet and/or any of the commercial on-line services such as America Online, Road Runner or Verizon Online. Network interface could also be a DSL modem or a cable modem. These services are also commercially available from Internet Service Provider (ISP) companies. This allows buyers to choose access service(s) from a wide range of on-line connections. Several commercial electronic mail servers include the above functionality. Microsoft's EXCHANGE SERVER 5.5 is a secure server-based electronic mail software package designed to link people and information over enterprise networks and the Internet. The product utilizes open standards based on Internet protocols. Users can exchange messages with enclosures such as files, graphics, video and audio. Alternatively, network interface 245 may be configured as a voice mail interface, web site, BBS, or electronic mail address, etc.

While the above embodiment describes a single computer acting, as central controller 200, those skilled in the art will realize that the functionality can be distributed over a plurality of computers. In one embodiment, central controller 200 is configured in a distributed architecture, wherein the databases and processors are housed in separate units or locations. Some controllers perform the primary processing functions and contain at a minimum RAM, ROM, and a general processor. Each of these controllers is attached to a Wide Area Network (WAN) hub, which serves as the primary communication link with the other controllers and interface devices. The WAN hub may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system. The certificate authority embodiment provides more details of such a distributed environment describing operations server 164, certificate authority 165, and settlement server 170. The hardware of these servers would be configured similarly to that described for central controller 200.

In one embodiment of the present invention, communications between buyers and the seller take place via electronic or wireless networks, with central controller 200 acting as a web-server. The buyer logs on to central controller 200, selects the energy product he or she is interested in, selects the derivative contract he or she wishes to purchase, examines the current market prices given by central controller 200, adds a quantity specifier and thereby creates order 100, and then disconnects from the network. Similarly, for redemptions, the buyer logs onto central controller 200 and submits a redemption request by supplying the details of the purchased contract. The central controller 200 authenticates the contract and then if it is valid calculates the redemption value of the contract. Central controller 200 then authorizes payment to the buyer.

Referring now to FIG. 4A, there is described buyer interface 300, which includes central processor (CPU) 405, RAM 415, ROM 420, clock 435, video driver 425, video monitor 430, communication port 440, input device 445, modem 450, and data storage device 460. Cryptographic processor 410, smart card reader 465 and biometric device 455 may be added for stronger authentication as described later. A microprocessor such as the 3 GHz Pentium 4 Processor made by Intel Corporation may be used for a CPU 305. Clock 435 is a standard real-time chip-based clock, which can serve to timestamp buyer order 100 produced with buyer interface 300.

Modem 450 may not require high-speed data transfer if most buyer orders 100 produced are text-based and not too long. If a cryptographic processor is required, the MPC180 micro-controller described above is used. The structure of biometric device 455 and smart card reader 465 will be described below in conjunction with the cryptographic authentication embodiment.

Data storage device 460 is a conventional magnetic-based hard disk storage unit such as those manufactured by Conner Peripherals or Maxtor. Message database 470 may be used for archiving buyer orders 100, while audit database 480 may be used for recording payment records and communications with the central controller 200.

There are many commercial software applications that can enable the communications required by buyer Interface 300, the primary functionality being message creation and transmission. EUDORA PRO manufactured by Qualcomm, Incorporated, for example, provides editing tools for the creation of messages as well as the communications tools to route the message to the appropriate electronic address. When the central controller 200 is configured as a web-server, conventional communications software such as a web browser may also be used. The buyer may use these browsers to transmit order 100. No proprietary software is required.

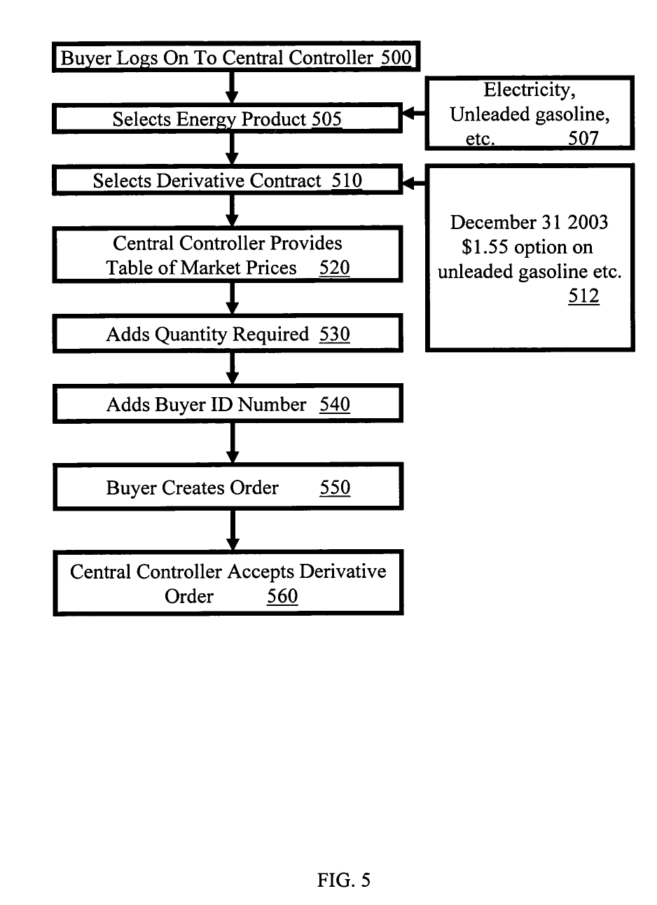

With reference to FIG. 5, a process is described by which the buyer formulates order 100. At step 500, the buyer logs on to central controller 200 using buyer modem 450 of buyer interface 300, establishing a communication link. It should be noted that the buyer might be an individual, a corporation, a partnership, government or any other entity. In one embodiment, central controller 200 has a page or website on the World Wide Web, allowing the buyer to provide information through the interface of a conventional web browser software.

At step 505, the buyer selects the energy product he wants to purchase by selecting from a list of possible energy products. As shown in box 507 products might include electricity or unleaded gasoline, etc. After the product is selected, in step 510 the buyer than selects a derivative contract on the product. As shown in box 512, this might be a Dec. 31 2004 option to buy unleaded gasoline at $1.95 a gallon, etc. At step 520 a form is displayed on video monitor 430 of buyer interface 300 (Note steps 505 and 510 could also be accomplished in the same way). This form is an electronic contract with a table of the current market price for the specific contract and selection fields and/or a number of blanks to be filled out by the buyer. Note that steps 505 and 510 could also be accomplished by using a selection box.

At step 530, the buyer adds the quantity he requires. At step 570 the buyer attaches his name and credit card information or a unique user ID number to order 100. This ID number is received from central controller 200 when the customer registers for the service, or is chosen by the customer and then registered with central controller 200 by phone. Central controller 200 maintains a database of customer ID numbers in customer database 255, and issues (or allows) only unique numbers. If less security is required, the user's telephone number or social security number could serve as the ID number since it has the advantages of being both unique and easily remembered. However, since credit card information is being stored, customers may be more comfortable with a more secure version. If additional security is required, those procedures described in the cryptographic embodiment may be implemented.

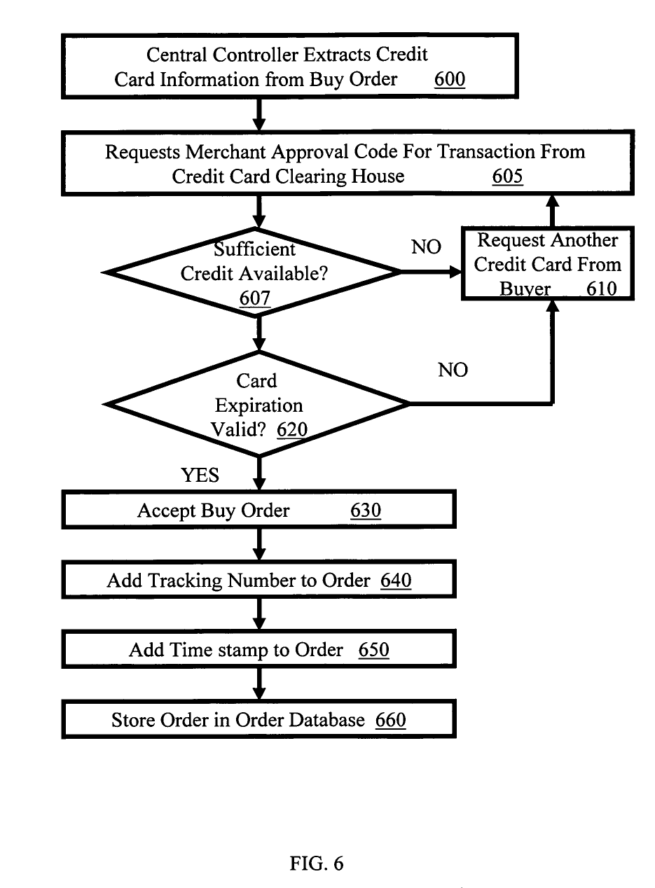

Once the above elements have been developed, the buyer transmits them to central controller 200 at step 560. The buyer does this by clicking on a “send” button located on the screen in which he entered the terms of order 100. At this step the buyer has placed an order for a derivative contract and proceeds to the payment method as described in FIG. 6.

Instead of a World Wide Web based interface, buyers may also transmit order 100 data via other means including electronic mail, PDAs, Electronic Data Interchange (EDI), voice mail, facsimile, or postal mail transmissions. With voice mail, the buyer calls central controller 200 and leaves order 100 in audio form. These orders 100 may be transcribed into digital text at central controller 200, or maintained in multiple formats. Central controller 200 supports a plurality of transmission methods, allowing for a wide variety of formats of order 100s.

Some formats may be changed, however, before further processing by central controller 200. Orders transmitted by mail in paper form, for example, may be scanned-in and digitized, using optical character recognition software to create digital text and then used to create orders 100. These embodiments are more fully described in the off-line embodiment described later.

Referring now to FIG. 6, order 100 is received and the credit card info is extracted either from the order or from the customer database if the customer only provided his unique identifier (ID). At step 605, central controller 200 requests a merchant approval code for the purchase price of the contract. The interface to the credit card processing centers is well known in the art and is standard for e-commerce on the Internet. One such interface is provided by Linkpoint International. Steps 607 and 620 are implemented as part of the merchant approval process as once the central controller 200 receives an authorization number it is then able to complete the transaction. If any part of the authorization fails, then at step 610, central controller 200 requests a new credit card from the buyer.

Once central controller 200 has received the authorization it accepts the buyer order at step 630. At step 640 a unique tacking number is added to the order 100. The central controller 200 timestamps order 100 at step 650 and stores order 100 in the order database 270 at step 660. Order database 270 contains a record for the order 100. The record contains fields such as status, tracking number, timestamp, security ID, quantity and customer ID. The status field has values of “pending,” “complete,” “redeemed” and “cancelled.” A status of “pending”, means that the order cannot currently be transacted. Either, central controller 100 is still processing it, or the buyer has temporarily suspended it. A “complete” order 100 is one that has been sold. A “redeemed” order is one that has been redeemed by the customer or has expired worthless. An “cancelled” order 100 can no longer be used.

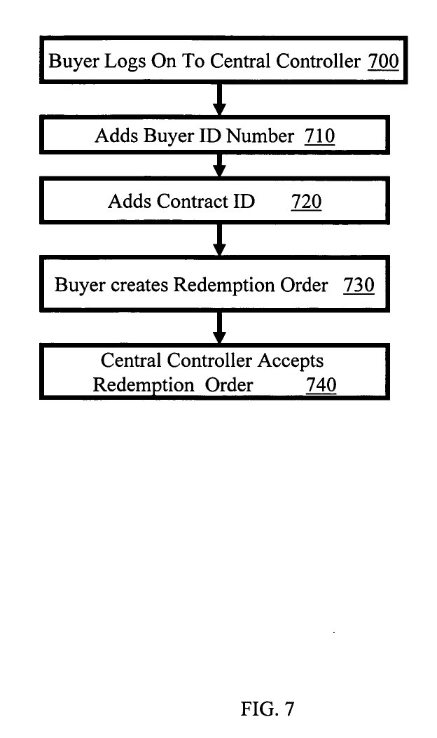

Referring again to FIG. 7, a process by which a buyer creates a redemption order is described. At step 700, the buyer logs on to central controller 200 using buyer modem 450 of buyer interface 300, establishing a communication link. This process is a mirror image of the process described above in the buyer selection process of FIG. 5. At step 710, the buyer provides his or her unique ID as described in FIG. 5. At step 720, the buyer is provided with a web page of their un-expired available contracts. At this point the buyer would select the contract he or she wanted to redeem. At step 730, the buyer creates the redemption order 160. This could be accomplished by pushing the send button on the given web page. At step 740, central controller accepts the redemption order.

Again, once the process is completed the seller has entered into a binding contract with the intermediary.

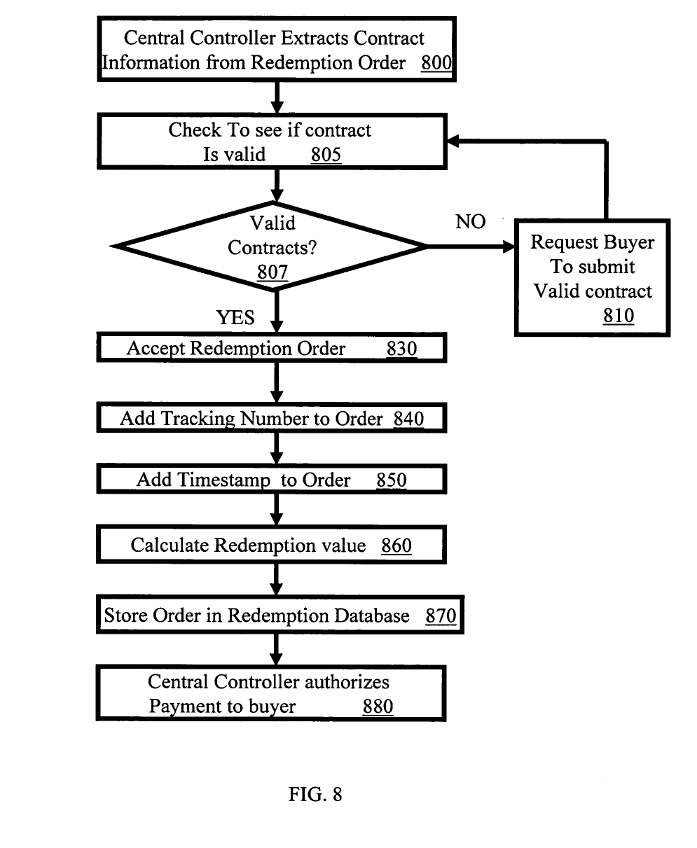

Referring now to FIG. 8, redemption order 160 is received and checked. At step 800, central controller 200 extracts the contract information from redemption order 160. At step 805, central controller 200 checks to see if the contract is a valid contract by checking order database 270. At step 807, the central controller examines the buyer's account to see if the buyer has a valid contracts. If the contract is not a valid contract the buyer is requested to submit a valid contract at step 810.

If all is well, the redemption order is accepted at step 830. At step 840, a unique tracking number is added to the redemption order 160. The central controller 200 timestamps redemption order 160 at step 850. At step 860, the central controller 200 calculates the redemption value of the contract. At step 870, the central controller 200 sets the status of the redemption order 160 to “redeemed” and stores it in the redemption database 280. At step 880 central controller authorizes payment of the redemption value to the buyer. This could be accomplished by either crediting the customer's account or by crediting their credit card account.

In an embodiment of the present invention, buyers and the seller communicate in an off-line manner with central controller 200. Rather than sending electronic mail or using web-based servers, the seller and buyers use a telephone, fax machine, postal mail, or other off-line communication tools.

A buyer may use a telephone, for example, to generate order 100. The buyer calls central controller 200 and is connected with an agent. The buyer provides the terms of order 100 such as product ID, contract type, expiration, quantity, price, etc. The buyer also provides his customer ID, password, or private key so that central controller 200 can authenticate his identity. The agent puts this data into digital form by typing it into a terminal. Order 100 is then transmitted to central controller 200 where it is added to order database 267 as described in the on-line embodiment. The agent then provides the buyer with the authorization code for their contract. A similar process would also allow the buyer to redeem their contracts via telephone, for example.

In another embodiment, the buyer/seller calls central controller 200 and is connected with a conventional Interactive Voice Response Unit (IVRU) which allows the buyer to enter some or all of the terms of order 100 without the assistance of a live agent. The buyer initially selects from a menu of products with the touch-tone keys of his phone. The specific contract type and expiration can also be selected in the same manner. The central controller 200 can then announce the schedule of market prices for each contract and the buyer can then use his touch-tone keys to select the quantity and price required. This information can then be used to generate order 100.

Buyers may also communicate with an agent at central controller 200 through faxes or postal mail. The agent receives the message and proceeds to digitize it and form order 100 as described above.

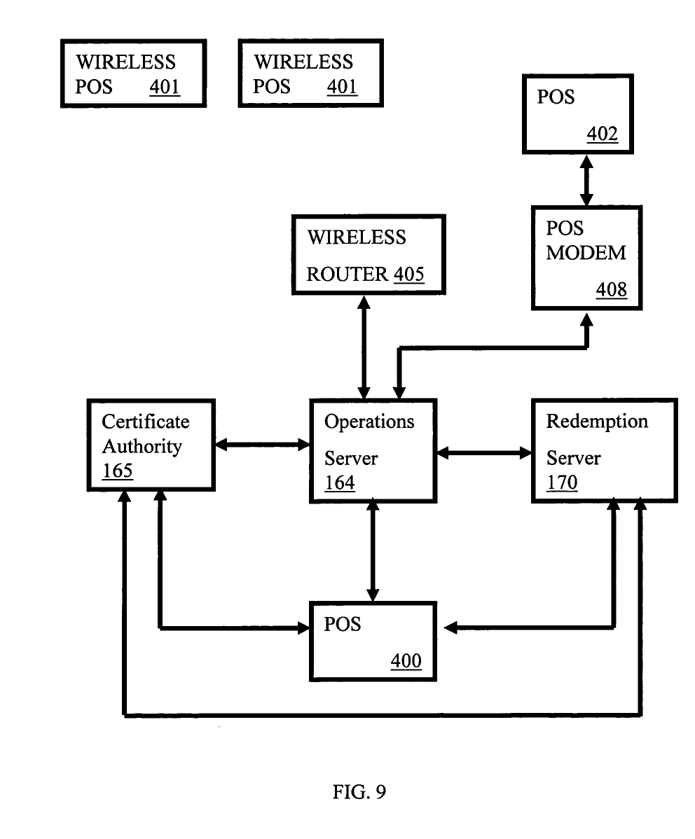

In at least one embodiment of the present invention, central controller 200 is separated into three distinct elements: operations server 164, certificate authority 165, and redemption server 170. Each server performs a distinct task in the process of managing order 100 and redemption orders 160. This separation makes it more difficult for attackers to compromise the system, as they must defeat the security of three separate systems, instead of one. As indicated in FIG. 9, these servers work in conjunction with POS 400 and wireless POS 401 and POS 402. Operations server 164 has the task of posting orders 100 and accepts all transactions previously authenticated by a certificate authority 165. The certificate authority 165 authenticates the identity of buyers while redemption server 170 processes all redemption orders 160 and the payments related to them. In this embodiment, each server type may be distributed over a number of servers.

There are two types of certificate authorities. The first is an internal server and the second is a trusted third party. This third party could also be the settlement server as well. For example, banks, insurance companies and other financial institutions could issue digital certificates establishing the identity of an individual and convey other pertinent information such as the individual's authority to represent an organization and his spending limit. Similarly, they could also certify the individual's ability to pay or deliver goods much as they do now when they issue letters of credit. These third parties have the financial capability to back up their certifications and thus can insure both buyers and sellers against fraud.

An example of such a system is the CERTAUTHORITY Solution manufactured by CertCo LLC. This system also comes with an optional tamper proof hardware based private key that is easy to transport and store securely.

The practice of using certificate authorities and settlement servers is well known in the art and need not be described here in detail. For reference, one of ordinary skill in the art may refer to Winfield Treese and Lawrence Stewart, Designing Systems for Internet Commerce, Addison Wesley, 1998.

This set of protocols describes one possible implementation of an infrastructure to support order 100. It is important to note that operations server 164, certificate authority and redemption server 170 can conceivably be the same entity. In this case the protocols are somewhat simplified but can still be achieved using the same software mentioned above.

According to another aspect of the invention, the buyer can interact with the POS using a physical token. The physical token could be a transponder similar to the Mobil SPEEDPASS made by Gilbarco. In this embodiment, the buyer could use the online embodiment to purchase the contract and then use the transponder for the redemption of the contract. Similarly, the buyer could purchase the contract at the POS system and instead of issuing the buyer a card, the seller could issue the buyer a transponder. This would simplify the redemption process for the buyer, who could just use the transponder to redeem the contract. The process is the same as the one outlined in FIGS. 3 and 4.

In an embodiment, the seller could bypass the steps for issuance by creating a loyalty card that would be issued free of charge to buyers. This would create an incentive for the buyer to return to the issuing provider in order to redeem the contract. In this embodiment the buyer would redeem the contract using the same process outlined in FIG. 4.

In one embodiment the derivative contract could be on a “basket”, i.e., a pool or collection of deliverable energy products. This contract could come in any of a variety of combinations. On form is where the whole basket is deliverable under the contract, e.g., an option to buy gasoline and electricity from potentially two different suppliers. The second version is where the seller has the option of choosing which member of the basket to deliver at expiration. An example would be an option contract to buy a gasoline from two different suppliers such as Shell and Chevron. At expiration the seller could select which gasoline to deliver. The third version is where the buyer has the option to select which member of the basket they desire to transfer or assign their energy contract(s).

There is also a need for the seller to administer the issuance and redemption of these micro derivative contracts. In monitoring the issuance and redemption of these contracts, the seller can hedge their exposure to fluctuations in the price of the underlying energy commodity thereby avoiding huge potential losses in the underwriting of these “insurance” policies. This could be achieved by trading the major contracts on the financial exchanges or by buying and selling the underlying commodity. In addition to hedging the exposure, the seller would also have to ensure the validity of the contract being presented.

In the financial field, practitioners have developed a myriad of exotic options that could be applicable to the non-commodity product world. These include contracts that have multiple underlying options or even other contracts as underlying options. Illustrative examples of these contracts include:
1) Future options—This is an option to buy a future contract. An example of such future option would be an option to buy a future contract on a tank full of gasoline.
2) Compound option—This is an option on an option, for example, a call option on an option to buy a 1 Kilowatt of electricity.
3) Asian options—The buyer pays the average price of the underlying option during the life of the option. The averaging could be defined over any periodicity, e.g., the daily average price or the weekly average price of gasoline.
4) Lookback options—Here the buyer pays the maximum or minimum price experienced over the life of the option. An example would be an option to buy a gasoline at the cheapest price the gas station sold gasoline over the life of the option.
5) Special options—Here the buyer would receive a discount on the price of the energy product at delivery. This would eliminate the need to develop location-based contracts. For example, the buyer could buy a contract to buy gasoline for 10 cents below the market price on the day of redemption.

Although the above list is only illustrative and not exhaustive, anyone skilled in the art will realize that any of the financial derivative structures are equally applicable to the energy products world.

Not all transactions require the transfer of the energy product from seller to the buyer on the expiration of the derivative contract. Just as in the financial markets, the derivative contracts could be settled for cash. And hence eliminate the added cost of shipping and handling the underlying product. This system also allows individuals from any state to participate in the market without worrying about the location of the redemption.

Further applications of the present invention are described below:
1) A customer buying a Dec. 6, 2004 forward contract for 30 gallons of unleaded 87 octane branded gasoline at $1.48 a gallon.
2) A customer buying a Dec. 6, 2004 option contract to buy 30 gallons of premium unleaded braded gasoline at $1.45 and paying $1.05 in option premium.
3) An individual buying a Aug. 15, 2004 forward contract on 100 Kilowatt-hours of SDGE electricity for delivery in California at $0.0723 per kWh.
4) A company buying a 1-year option to buy 50 kWh of peak demand electricity from an energy supplier utility at $0.0925 per kWh and paying $5.25 in option premium.
5) A customer buying a Jun. 30, 2005 forward contract to buy 150 gallons of diesel at $1.35 in Austin Texas.
6) A company buying a Nov. 15, 2004 option to buy 50 Therms of natural gas for $1.02 per Therm and paying $2.75 for the contract
7) An ambulance service buying a Jan. 10, 2005 option to buy unleaded gasoline at the average daily price paid in New York City during the month of December 2004.
8) A customer buying an option that provided his consumption of energy utilities is below or equal to its historical value, the most he will pay for his utility bill will be $150.00 for the month

The above listed examples are merely exemplary and those skilled in the art will agree that many different applications are possible within the scope of the invention.

Having described preferred embodiments of the present invention, it is noted that modifications and variations can be made by persons skilled in the art in light of the above teachings. It is therefore to be understood that changes may be made in the particular embodiments of the invention disclosed which are within the scope and spirit of the invention as outlined by the appended claims.

What is claimed is:

1. An electronic system for facilitating trading of derivative contracts, comprising:
a transmitter for transmitting an order for a micro derivative contract from a buyer to a seller; and
a controller associated with the seller for receiving the order transmitted from the transmitter over the electronic system, the controller assigning an authorization identifier corresponding to the micro derivative contract, the controller storing the authorization identifier in a database and transmitting an acknowledgement to the buyer.

2. The system of claim 1, wherein the micro derivative contract has a predetermined expiration condition.

3. The system of claim 1 wherein the central controller authenticates the identity of the buyer by checking an electronic smart card submitted by the buyer with an issuer of the electronic smart card.

4. The system of claim 3 wherein the authentication is carried out using cryptographic means.

5. The system of claim 1 wherein the transmitter is a point of sale terminal.

6. The system of claim 5 wherein the point of sale terminal is wirelessly connected to the controller for transmitting and receiving data.

7. The system of claim 1 wherein the electronic system is at least one of the Internet, an intranet, a local area network and a wide area network.

8. The system of claim 1 wherein the controller is a computer system.

9. A computer based method for facilitating contractual transactions using an electronic system between a buyer and a seller, the method comprising:
receiving at the seller an order to buy a micro derivative contract for at least one energy product from the buyer, the order being transmitted from a transmitter, said seller having a controller including a database stored in a storage;
assigning an authorization identifier corresponding to said micro derivative contract;
storing said authorization identifier in the database; and transmitting acknowledgement to the buyer.

10. The method of claim 9, wherein at least one of the buyer and the seller stipulates a price for the micro derivative contract they will trade.

11. The method of claim 10, wherein at least one of the buyer and the seller stipulates the expiration of the micro derivative contracts that they will trade.

12. The method of claim 11, wherein the buyer purchases the energy product at a predetermined contract price.

13. The method of claim 9, wherein the buyer's order further comprises:
a quantity specifier.

14. The method of claim 13, further comprising the step of:
authenticating by the controller the identification and authority of the buyer.

15. The method of claim 14, wherein the step of authenticating is performed by comparing the buyer's identification, with a buyer identification previously stored in the central controller database.

16. The method of claim 14, wherein the step of authenticating comprises: authenticating the an electronic smart card submitted by the buyer with an issuer of the electronic smart card.

17. The method of claim 14, wherein the step of authenticating is performed using cryptographic means.

18. The method of claim 9, further comprising the step of:
providing a payment to the seller.

19. The method of claim 18, wherein the step of providing payment to the seller is performed using an automatic payment management system.

20. The method of claim 18, wherein the payment is in form of a currency.

21. The method of claim 9, further comprising:
transferring said contract to the buyer.

22. The system of claim 9 wherein the electronic system is at least one of the Internet, an intranet, a local area network and a wide area network.

23. The system of claim 9 wherein the controller is a computer system.

24. A computer based method for facilitating the redemption of micro derivatives contracts on energy products in transacting contracts between a buyer and a seller, the method comprising:
receiving at the seller a redemption order for a micro derivative contract from the buyer, the redemption order being transmitted from a transmitter, said seller having a controller including database storage;
authenticating the validity of the redemption order;
assigning a redemption identifier corresponding to said redemption order;
storing said redemption identifier in the database; and authorizing delivery of energy product to buyer.

25. The method of claim 9, wherein at least one communication between the buyer and the seller is conducted over an electronic network.

26. The method of claim 24, wherein at least one communication of the buyer with the central controller is achieved using at least one software agent.

27. The method of claim 24, wherein at least one communication between the buyer and the seller is conducted over a telecommunications network.

28. The method of claim 24, wherein the micro derivative contract is a forward contract.

29. The method of claim 24, wherein the micro derivative contract is an option contract.

30. A computer based method for facilitating the redemption of micro derivatives contracts on energy products in transacting contracts between a buyer and a seller, the method comprising:
receiving at the seller a redemption order for a micro derivative contract from the buyer, the redemption order being transmitted from a transmitter, said seller having a controller including database storage;
authenticating the validity of the redemption order;
assigning a redemption identifier corresponding to said redemption order;
storing said redemption identifier in the database; and
settling a redemption value of the redemption order in cash.

31. A device having stored programs executable by a computer to perform method steps for facilitating the issuance of micro derivatives contracts on energy products in transmitting contracts between a buyer and an seller, comprising:
receiving at the seller an order to buy a micro derivative contract from the buyer, the order being transmitted from a transmitter, said seller having a controller including a database storage;
assigning an authorization identifier corresponding to said contract;
storing said authorization identifier to said database; and
transmitting acknowledgement to the buyer.

32. A device having stored programs executable by a computer to perform method steps for facilitating the redemption of micro derivatives contracts on energy products in transmitting contracts between a buyer and an seller, comprising:
receiving at the seller a redemption order for a specific derivative contract from the buyer, the redemption order being transmitted from a transmitter, said seller having a central controller including database storage;
authenticating the validity of said redemption order;
assigning a redemption identifier corresponding to said redemption order;
storing said redemption identifier to said database; and
authorizing delivery of the energy product to buyer.
